(19) United States
(12) Patent Application Publication
(10) Pub. No.: US 2025/0348431 A1
(43) Pub. Date: Nov. 13, 2025

(54) MEMORY TAGGING IN A COMPUTING SYSTEM

(71) Applicant: QUALCOMM Incorporated, San Diego, CA (US)

(72) Inventors: Hiral NANDU, South San Francisco, CA (US); Subbarao PALACHARLA, San Diego, CA (US); Christophe AVOINNE, San Diego, CA (US); Radhika VAID, San Diego, CA (US); Kedar BHOLE, San Diego, CA (US)

(21) Appl. No.: 18/657,570

(22) Filed: May 7, 2024

(51) Int. Cl. G06F 12/0871; G06F 12/0868; G06F 12/0891

(52) U.S. Cl. CPC G06F 12/0871; G06F 12/0868; G06F 12/0891

(57) ABSTRACT

Some aspects of the disclosure provide various techniques for implementing memory tagging to protect memory with reduced performance degradation, lower latency impact on the data path, and reduced hardware overhead. Furthermore, the memory tagging techniques can avoid head-of-line (HOL) blocking in memory access and are capable of delivering high bandwidth. In some aspects, a computing apparatus can implement a tag cache in a portion of a system cache and using a memory tagging unit to manage allocation tags cached in the tag cache.

### TECHNICAL FIELD

The technology discussed below relates generally to electronic devices and, more particularly, memory protection with metadata.

### INTRODUCTION

In a computing system, an attacker can exploit memory violations to deliver malicious payloads, to gain control of the system or obtain privileged information. Memory tagging is a technique used in computer systems to track the ownership or state of memory regions. With memory tagging, metadata (e.g., tags) can be assigned to memory blocks or regions to identify their intended usage and/or to detect unauthorized access. There are various implementations of memory tagging, and the general concept involves associating a unique identifier (e.g., a tag) with each memory block. These tags can represent different attributes such as ownership, permissions, or other metadata relevant to memory management. Memory tagging provides a mechanism to detect different categories of memory safety violation. In one example, spatial safety is violated when an object is accessed outside of its true bounds. In another example, temporal safety is violated when a reference to an object is used out of scope, typically after the memory backing the object has been reallocated.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Various method, system, device, and apparatus embodiments may also include additional features. Some aspects of the disclosure provide various techniques for implementing memory tagging to protect memory with reduced performance degradation, lower latency impact on the data path, and reduced hardware overhead. Furthermore, the memory tagging techniques can avoid head-of-line (HOL) blocking in memory access and are capable of delivering high bandwidth. In some aspects, a computing apparatus can implement a tag cache in a portion of a system cache and using a memory tagging unit to manage allocation tags cached in the tag cache.

One aspect of the disclosure provides a computing apparatus that includes a main memory, a system cache, and a memory controller coupled to the main memory and the system cache. The memory controller is configured to: initiate a read operation to the system cache to access a first memory tagging (MT) data; retrieve the first MT data from the main memory, in response to determining that the first MT data is absent in the system cache; initiate a read operation to the system cache to obtain a first allocation tag (AT) associated with the first MT data; retrieve a plurality of ATs from the main memory, in response to determining that the first AT is absent in the system cache, the plurality of ATs comprising the first AT; store the plurality of ATs in a first cache line of the system cache; and align the first AT and the first MT data in a second cache line of the system cache.

One aspect of the disclosure provides a method of cache memory management in a computing apparatus. The method includes: initiating a read operation to a system cache to access a first memory tagging (MT) data; retrieving the first MT data from a main memory associated with the system cache, in response to determining that the first MT data is absent in the system cache; initiating a read operation to the system cache to obtain a first allocation tag (AT) associated with the first MT data; retrieving a plurality of ATs from the main memory, in response to determining that the first AT is absent in the system cache, the plurality of ATs comprising the first AT; storing the plurality of ATs in a first cache line of the system cache; and aligning the first AT and the first MT data in a second cache line of the system cache.

One aspect of the disclosure provides a computing apparatus including: a main memory configured to store memory tagging (MT) data and associated allocation tag (AT); a system cache configured to cache the MT data and the AT; and a memory controller. The memory controller is configured to: store a first MT data of the MT data in a first cache line of the system cache; store a first AT associated with the first data, in the first cache line; and store a plurality of second ATs in a second cache line of the system cache.

These and other aspects of the present disclosure will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain examples and figures below, all implementations can include one or more of the advantageous features discussed herein. In other words, while one or more implementations may be discussed as having certain advantageous features, one or more of such features may also be used in accordance with the various examples discussed herein. In a similar fashion, while examples may be discussed below as device, system, or method implementations, it should be understood that such examples can be implemented in various devices, systems, and methods.

### BRIEF DESCRIPTION OF THE DRAWINGS

FIG. 1 is a block diagram of a computing apparatus including a memory tagging unit (MTU) for memory tagging operations according to some aspects of the disclosure.

FIG. 2 is a block diagram illustrating an exemplary system cache of a computing apparatus according to some aspects of the disclosure.

FIG. 3 is a flow chart illustrating exemplary memory tagging operations during a cold start according to some aspects of the disclosure.

FIG. 4 is a flow chart illustrating a first example of memory tagging operations for a metadata hit in a tag cache portion according to some aspects of the disclosure.

FIG. 5 is a flow chart illustrating a second example of memory tagging operations for a metadata hit in a tag cache portion according to some aspects of the disclosure.

FIG. 6 is a flow chart illustrating an example of memory tagging operations for a metadata hit and MT data read hit in a cache line according to some aspects of the disclosure.

FIG. 7 is a flow chart illustrating an example of memory tagging operations for a metadata hit and MT data write hit in a cache line according to some aspects of the disclosure.

FIG. 8 is a flow chart illustrating an eviction operation in a system cache including a tag cache portion for memory tagging operations according to some aspects of the disclosure.

FIG. 9 is a flow chart illustrating a method of memory tagging using a system cache including a tag cache portion and a memory tagging unit according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of the disclosure will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, firmware, or any combination thereof. Whether such elements are implemented as hardware or software depends upon the particular application and design constraints imposed on the overall system.

Memory tagging is a memory protection technique that uses a pair of tags (lock and key) to validate memory accesses. Locks can be set on memory and keys are provided during memory access. When the key matches the lock for a particular memory, the access is permitted. When the lock and key do not match, an error occurs. For example, memory locations can be tagged by adding four bits (4 b) of metadata (e.g., tag) to each 16 bytes (16 B) of physical memory. This is referred to as the tag granule. Tag granule refers to the size of the memory region or block to which metadata is applied in memory tagging systems. In a memory tagging system, a memory is divided into granules, and each granule is associated with metadata that provides additional information about the memory region covered by the metadata (e.g., a tag). Memory access violations can be detected when the lock and the key are different. In this disclosure, the terms metadata and tag may be used interchangeably.

Some aspects of the present disclosure provide various techniques for implementing memory tagging to protect memory with reduced performance degradation, lower latency impact on the data path, and reduced hardware overhead. Furthermore, the memory tagging techniques can avoid head-of-line (HOL) blocking in memory access and are capable of delivering high bandwidth. In some aspects, a computing apparatus can implement a tag cache in a portion of a system cache and using a memory tagging unit to manage allocation tags cached in the tag cache.

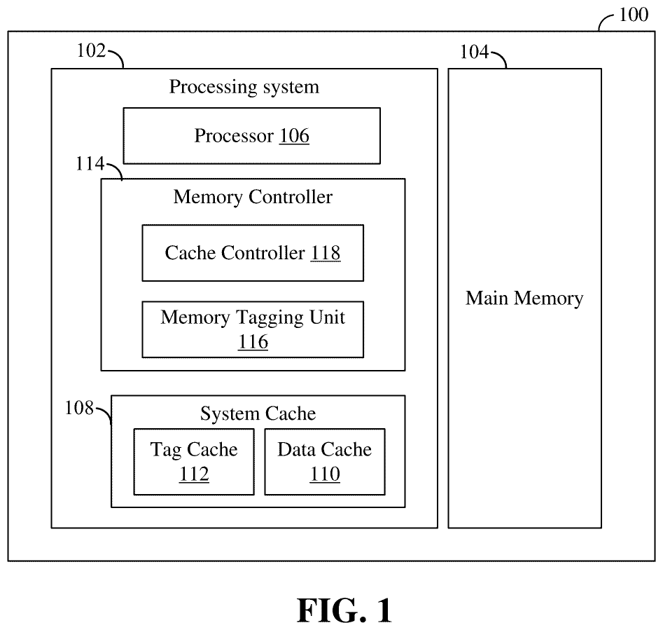

FIG. 1 is a block diagram of a computing apparatus 100 including a memory tagging unit (MTU) for memory tagging operations in accordance with some aspects of the present disclosure. In some aspects, the apparatus 100 may be implemented in one or more of a variety of computing devices, including, but not limited, to a personal computer, a server, a laptop, a tablet, a smartphone, a system on a chip (SoC), or other computing devices. The computing apparatus 100 can include a processing system 102 and a main memory 104 for storing various data that can be accessed by the processing system 102 during operations. The processing system can include one or more processors (a processor 106 illustrated as an example) configured to perform various functions, processes, and procedures. The apparatus further includes a system cache 108 for caching the data of the main memory. When memory tagging is used to protect the main memory 104, the system cache can cache metadata (e.g., allocation tags) for accessing memory protected by memory tagging.

In some aspects, the main memory 104 can include one or more memories that can include a variety of types of memories. In some examples, the main memory 104 may include volatile memory, non-volatile memory (NVM), or a combination of volatile memory and NVM. Some examples of the volatile memory may include various types of random access memory (RAM) such as dynamic RAM (DRAM). In some aspects, the NVM can include flash memory (e.g., NAND memory), phase-change memory (PCM), hard disk drives, solid state storages, etc.

In some aspects, the processor 106 can access (e.g., write or read) data in the system cache 108 and/or the main memory 104. The system cache 108 can store frequently accessed data and instructions in a data cache 110 such that the processor 106 does not need to fetch the data from the main memory 104. In some aspects, the system cache can be organized into multiple levels (e.g., L1, L2, and L3 caches) that form a hierarchy. In some aspects, the system cache 108 can include a tag cache 112 for storing metadata (e.g., tags) for use in memory tagging operations when access of the main memory 104 is protected by memory tagging. When the processor 106 needs to access (e.g., read or write data) the main memory, the processor may obtain the metadata from the system cache (e.g., tag cache 112) and the corresponding data in the data cache 110, for example, in a single cache line. The system cache can provide spatial locality caching and temporal locality caching for the metadata and the corresponding cached data.

The processing system can include a memory controller 114 for controlling access of the main memory 104 and the system cache 108. The processor 106 can send read and write commands or requests to the memory controller 114 that performs the corresponding operations to read data from or write data to the main memory and/or system cache. In some aspects, the memory controller 114 can include a memory tagging unit (MTU) 116 and a cache controller 118. In some examples, all or some functions of the memory controller 114 can be included in the processor 106. In some examples, the memory controller 114 can be included in the processor 106. The memory controller 114 can perform various functions for accessing (e.g., reading and writing) and managing the main memory 104 and system cache 108. The cache controller 188 can perform various functions for managing the system cache 108, for example, cache access, cache replacement and eviction, cache coherency, prefetching, and cache write policies, etc. The MTU 116 can perform various functions for controlling access to the main memory 104 and system cache 108 using memory tagging.

In some aspects, the apparatus 100 can use two types of tags (metadata) for memory tagging. A logical tag is stored in a memory pointer, usually at the higher bits of the pointer. An allocation tag (AT) is the tag associated with a particular range or block of memory in the physical address space, against which the logical tag from pointer is compared. The logical tag must match the AT for the memory access to be valid. If the logical tag does not match the AT, a memory violation occurs and access can be denied.

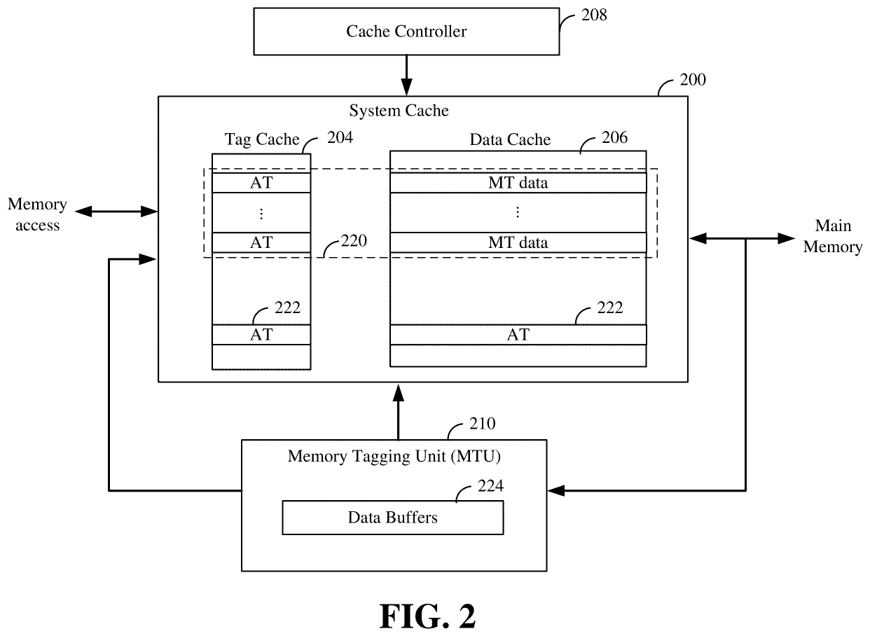

FIG. 2 is a block diagram illustrating an exemplary system cache 200 including a tag cache portion and a data cache portion according to some aspects of the disclosure. In one example, the system cache 200 can be used as the system cache 108 (see FIG. 1) or a system cache in any processing system. For clarity and brevity, certain well-known components or elements that are not directly relevant to the present disclosure may be omitted from the figure.

The system cache 200 includes a tag cache portion 204 for storing metadata (e.g., allocation tags) and a data cache portion 206 for caching data and/or metadata from the main memory (e.g., main memory 104 shown in FIG. 1). The system cache 200 can have any suitable size and provide a plurality of cache lines. Access to the system cache is by cache line. A cache line is the smallest unit of data that can be accessed (e.g., read or write) in the system cache. A cache line can correspond to a fixed-size block of data (e.g., 64 bytes of data in the data cache portion and 16 bits of AT in the tag cache portion). Access to the system cache 200 can be managed by a cache controller 208 in cooperation with a memory tagging unit (MTU) 210. In one example, the cache controller 208 and the MTU 210 can correspond to the cache controller 118 and the MTU 116 (shown in FIG. 1), respectively. In some aspects, the MTU 210 can be a co-processor of the cache controller 208 that together control the access and operations of the main memory and system cache. In some examples, the MTU can be included in the cache controller 208.

In some aspects, in a same cache line (e.g., cache line 220), the apparatus can store an allocation tag (AT) (e.g., 4-bit metadata) in the tag cache portion 204 and corresponding memory tagging (MT) data (e.g., 16 bytes of data) in the data cache portion 206. Each cache line can store multiple ATs and the corresponding MT data. Therefore, a single fetch of a cache line can retrieve multiple ATs and corresponding MT data. The tag cache portion 204 can also store AT valid and dirty bits. The AT valid bit can indicate whether the cache tag portion contains a valid AT or not. If the valid bit is not set, the cached AT is invalid, requiring fetching the AT from the main memory. The AT dirty bit indicates whether the cached AT has been modified since it was last loaded from memory. When cached data is modified in the cache, the dirty bit is set to indicate that the data in the cache is different from the data in main memory. If the AT dirty bit is set, the cached tag needs to be written back to the main memory before it can be replaced with new data.

In some aspects, the system cache 200 stores the allocation tag (AT) and the corresponding cached data in the same cache line (e.g., cache line 220) to provide temporal locality caching. Furthermore, because the AT and corresponding cached data are stored in the same cache line (AT in the tag cache portion 204 and cached data in data cache portion 206), memory tagging latency can be reduced. In one example, the cache controller 208 can use a single fetch (e.g., 32 bytes or 64 bytes) to prefetch multiple ATs and associated data for multiple cache lines from a main memory (e.g., main memory 104 of FIG. 1). In some aspects, the cache controller 208 and MTU 210 can process memory tagging misses and evicts in the system cache. In some aspects, the MTU 210 can include one or more buffers (e.g., data buffers 224) that can be used to optimize AT writes and evicts. For example, the MTU 210 can use a write coalescing buffer (WCB) to aggregate or merge multiple AT writes/evicts into a single larger memory operation to reduce memory access to the system cache and main memory.

Aspects of the present disclosure provide techniques that use a system cache (e.g., system cache 200) to cache metadata for memory tagging operations. The techniques can reduce the hardware cost of the system cache because no separate tag cache is used for caching metadata. Furthermore, the techniques enable flexible sizing of a tag cache portion in the system cache by changing (e.g., upsized or downsized) the size of the tag cache portion dynamically. The techniques can increase temporal locality of the cached metadata by storing the metadata and the corresponding cached data in the same cache line.

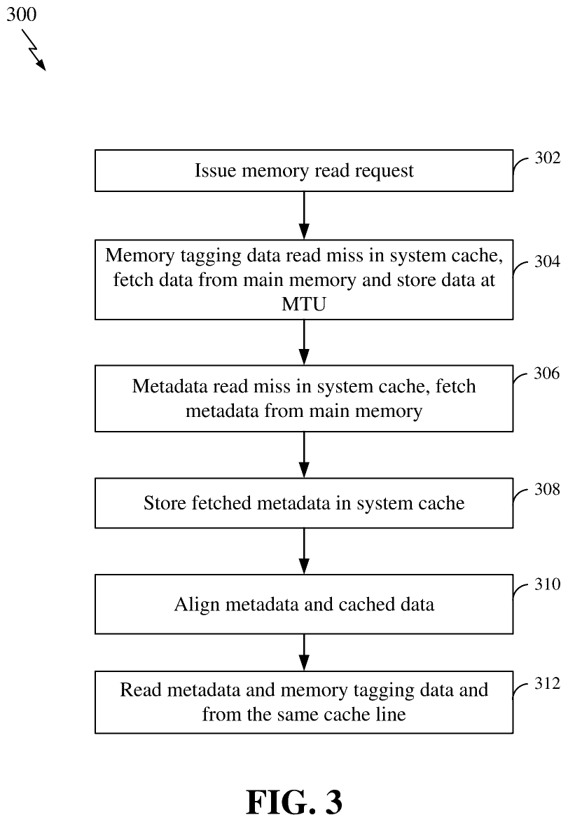

FIG. 3 is a flow chart illustrating exemplary memory tagging operations during a cold start according to some aspects of the disclosure. The operations can be performed using the system cache described above in relation to FIGS. 1 and 2. In a cold start, the system cache 200 (FIG. 2) does not have any stored metadata (e.g., AT) and cached data. At block 302, the apparatus (e.g., processor 106 of FIG. 1) can issue a memory read request to a memory controller (e.g., cache controller 208 of FIG. 2). The memory read request can include the address of the memory location, along with metadata information needed for memory tagging the memory location.

At block 304, the apparatus (e.g., cache controller 208 of FIG. 2) can determine that a memory tagging read miss occurred because the desired data is not available in the system cache. In this case, the apparatus can issue a data read command to the main memory and MTU. The data read command can cause the MTU to fetch the data from the main memory and store the fetched data at a buffer (e.g., data buffers 224 of FIG. 2) at the MTU.

At block 306, the apparatus can issue a metadata read command to the cache controller. In response, the cache controller can read the system cache, which results in a metadata miss in the system cache because the metadata is not in the cache at this point. In this case, the apparatus can issue a metadata read command to fetch the metadata from the main memory (e.g., DRAM).

At block 308, the apparatus can allocate space in the system cache to store the metadata fetched from the main memory. In one example, the apparatus can allocate an AT sub-cache (e.g., 64 bytes sub-cache 222 of FIG. 2) in the system cache for storing the prefetched metadata. Then, the cache controller can fetch the metadata from the main memory and store the metadata in the system cache. For example, the fetched metadata can include a plurality of ATs for memory tagging that can be prefetched from the main memory in a single read operation. After the metadata is stored in the system cache, the cache controller can notify the MTU.

At block 310, the apparatus (e.g., MTU) can align the metadata and memory tagging (MT) data in a same cache line of the system cache. For example, the apparatus can allocate memory in the same cache line (e.g., cache line 220) to store the MT data (e.g., 64 bytes) in the data cache portion and metadata (16 bits) in the tag cache portion. In some aspects, the MTU can receive the metadata (e.g., 16 bits) and the MT data (e.g., 64 bytes) separately and align the metadata and the MT data. Further, the MTU can forward the metadata to a network-on-chip (e.g., processor 106 of FIG. 1). The apparatus can fetch the data from the main memory using an incrementing (INCR) burst or wrapping (WRAP) burst. When the INCR burst is used, the memory address increments sequentially for each data transfer. The WRAP burst is similar to the INCR burst, but once the address reaches the boundary of the wrap (defined by the burst length), it wraps around to the starting address of the burst.

At block 312, the apparatus can read the metadata and the MT data from a same cache line of the system cache. Because the metadata and MT data are in the same cache line, the apparatus can read them in a single read operation, thus reducing latency of memory access.

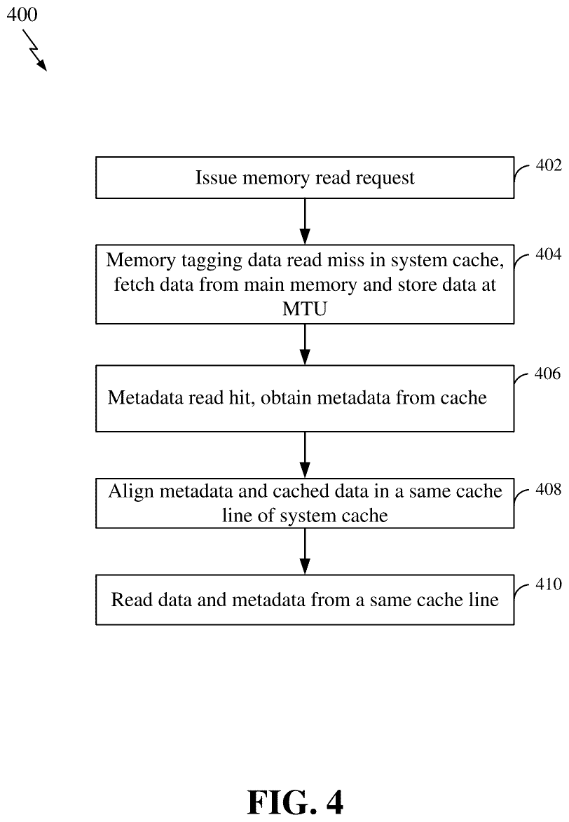

FIG. 4 is a flow chart illustrating a first example of memory tagging operations for a metadata hit in a system cache according to some aspects of the disclosure. In one example, the operations can be performed using the system cache described above in relation to FIGS. 1 and 2. When a metadata hit occurs, the system cache has the desired metadata (e.g., tag) stored in the system cache (e.g., tag cache portion 204 of FIG. 2). At block 402, the apparatus (e.g., processor 106 of FIG. 1) can issue a memory read request to a memory controller (e.g., cache controller 208 of FIG. 2). The memory read request can include the address of the memory location, along with metadata information used for memory tagging the data.

At block 404, the apparatus (e.g., cache controller 208 of FIG. 2) can determine that a MT data read miss occurred because the desired data is not available in the system cache. In this case, the apparatus can issue a data read command to the MTU. The data read command can cause the MTU to fetch the MT data from the main memory and store the fetched MT data at a buffer of the MTU (e.g., data buffers 224 of FIG. 2).

At block 406, the apparatus (e.g., MTU 210 of FIG. 2) can issue a metadata read command to read the metadata from the system cache. In response, the metadata read command can result in a metadata read hit because the metadata is stored in the system cache (e.g., in AT sub-cache 222 of FIG. 2). In this case, the MTU can obtain the metadata from the system cache (e.g., from the AT sub-cache 222 of FIG. 2). The MTU can temporally save the obtained metadata in a data buffer (e.g., data buffers 224 of FIG. 2).

At block 408, the MTU can align the metadata and MT data. For example, the apparatus can allocate memory in the same cache line (e.g., cache line 220 of FIG. 2) to store the aligned MT data (e.g., 64 bytes) in the data cache portion and metadata (16 bits) in the tag cache portion. Then, the MTU can fill the cache line with the aligned metadata and MT data stored in its data buffer in the tag cache portion and data cache portion, respectively.

At block 410, the apparatus can read the metadata and the MT data from the same cache line of the system cache. Because the metadata and MT data are in the same cache line, the apparatus can read them in a single memory read operation, thus reducing latency of memory access.

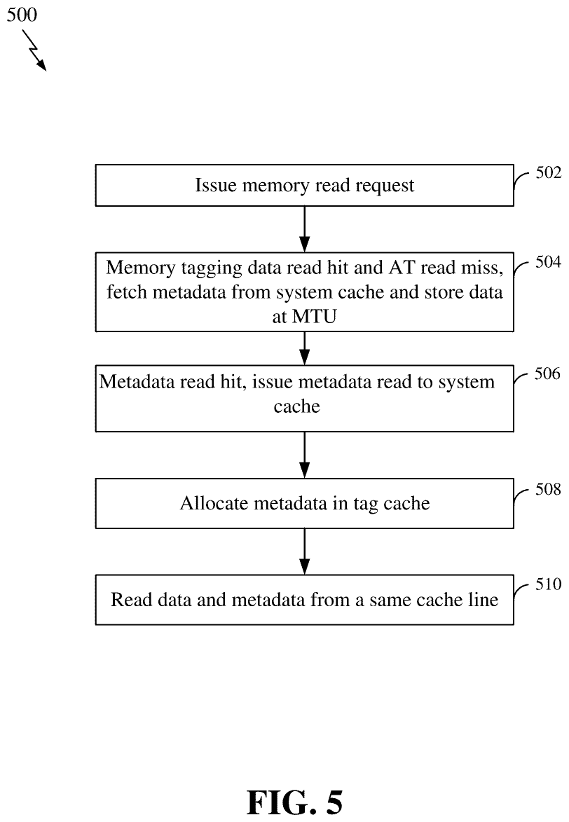

FIG. 5 is a flow chart illustrating a second example of memory tagging operations for a metadata hit according to some aspects of the disclosure. The operations can be performed using the system cache described above in relation to FIGS. 1 and 2. At block 502, an apparatus (e.g., processor 106 of FIG. 1) can issue a memory read request to a memory controller (e.g., cache controller 208 of FIG. 2). The memory read request can include the address of the memory location for the desired data, along with metadata information needed for memory tagging.

At block 504, the apparatus (e.g., cache controller 208 of FIG. 2) can determine that a data read hit occurs because the desired MT data is available in the system cache, but the metadata (e.g., AT) read results in a metadata read miss because the metadata is not in the system cache.

At block 506, the apparatus (e.g., MTU 210 of FIG. 2) can issue a metadata read command to the cache controller. In response, the cache controller can read the system cache and results in a metadata hit because the metadata is stored in the system cache. In this case, the MTU can read the metadata (e.g., AT sub-cache 222 of FIG. 2) from the system cache and store the metadata at a buffer (e.g., data buffers 224 of FIG. 2) of the MTU, at least temporarily.

At block 508, the apparatus can allocate the metadata (16 bits) in the tag cache portion (e.g., tag cache portion 204 of FIG. 2), corresponding to a same cache line where the corresponding MT data is stored in the data cache (e.g., data cache portion 206).

At block 510, the apparatus can read the metadata and the associated MT data from a same cache line (e.g., cache line 220 of FIG. 2) of the system cache. Because the metadata and MT data are in the same cache line, the apparatus can read them in a single memory read operation, thus reducing latency of memory access.

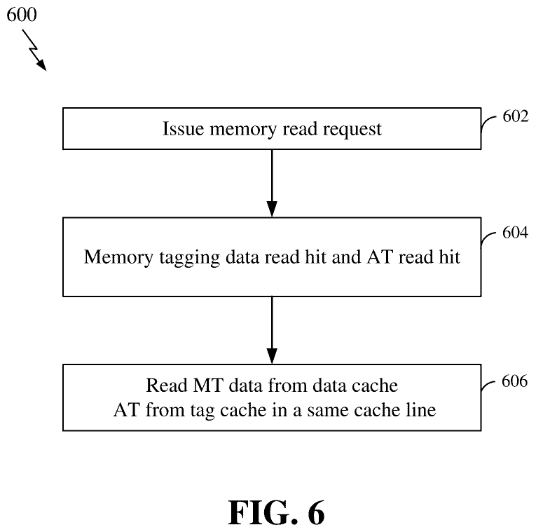

FIG. 6 is a flow chart illustrating an example of memory tagging operations for a metadata read hit and MT data read hit in a cache line according to some aspects of the disclosure. The operations can be performed using the system cache described above in relation to FIGS. 1 and 2, or any system cache for a computing apparatus. At block 602, the apparatus (e.g., processor 106 of FIG. 1) can issue a memory read request. The memory read request can include the address of the memory location for the desired MT data, along with metadata information needed for memory tagging.

At block 604, the apparatus (e.g., cache controller 208 of FIG. 2) can determine that a MT data read hit and AT read hit occur because the MT data and AT are both available in the system cache at the same cache line. For example, the AT is stored in a tag cache portion (e.g., tag cache portion 204 of FIG. 2) and the MT data is stored in a data cache portion (e.g., data cache 206 of FIG. 2) of the system.

At block 606, the apparatus can read the MT data from the data cache portion and the AT from the tag cache portion, which are both stored in the same cache line. Therefore, the apparatus can fetch both MT data and AT in a single fetch operation, thus reducing memory access latency.

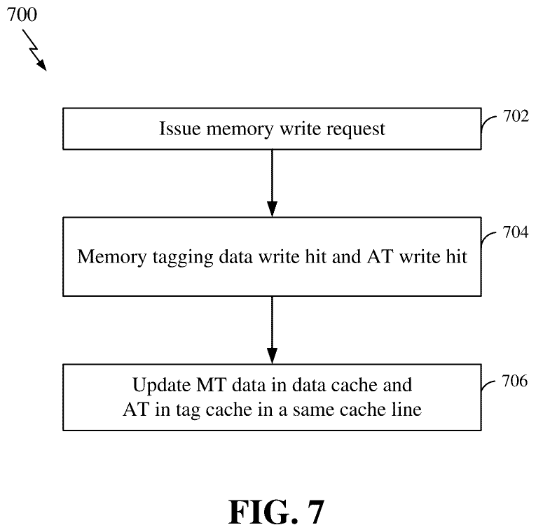

FIG. 7 is a flow chart illustrating an example of memory tagging operations for a metadata hit and MT data write hit in a cache line according to some aspects of the disclosure. The operations can be performed using the system cache described above in relation to FIGS. 1 and 2, or any system cache of a computing apparatus. At block 702, the apparatus (e.g., processor 106 of FIG. 1) can issue a memory write request. The memory write request can include the address of the memory location for the MT data, along with metadata information needed for memory tagging.

At block 704, the apparatus (e.g., cache controller 208 of FIG. 2) can determine that a MT data write hit and AT hit occur because the MT data and AT are both available in the system cache at the same cache line. For example, the AT is stored in a tag cache portion (e.g., tag cache portion 204) and the MT data is stored in a data portion (e.g., data cache portion 206) of the system cache.

At block 706, the apparatus can update (write) the MT data in the data cache portion and the AT in the tag cache portion, which are both stored in the same cache line. Therefore, the apparatus can update both MT data and AT in a single write operation, thus reducing memory access latency.

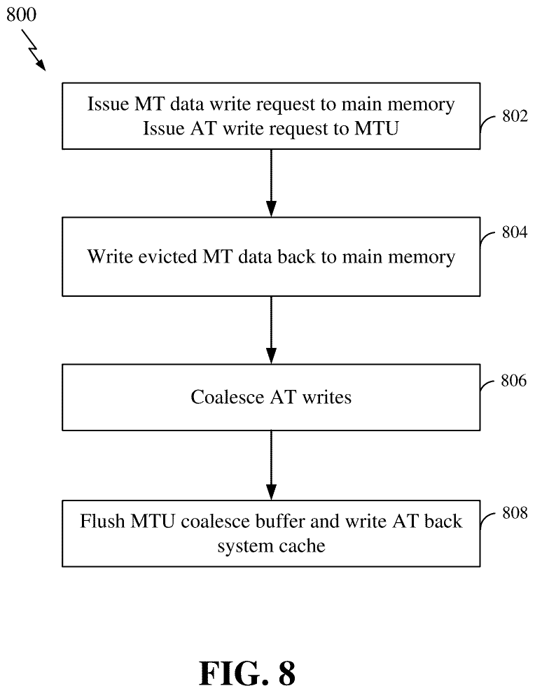

FIG. 8 is a flow chart illustrating an example of MT data and AT eviction in a system cache for memory tagging operations according to some aspects of the disclosure. The operations can be performed using the system cache described above in relation to FIGS. 1 and 2, or any system cache in a computing apparatus.

At block 802, the apparatus (e.g., cache controller 208 of FIG. 2) can issue a MT data write request to the main memory and an AT write request to the MTU, thus evicting the MT data and the associated AT from the system cache. In this example, the AT and the MT data are stored in the same cache line. Eviction can occur when a cache line needs to be replaced to make space for a new cache line. For example, eviction can happen when the cache is full, and new data needs to be brought into the system cache from the main memory. The process of eviction involves selecting a cache line to be replaced and then replacing its contents with the new data from the main memory. In some cases, multiple cache lines may be prefetched or loaded speculatively into the system cache. If these cache lines are not subsequently accessed, they may be evicted to make space for more relevant data.

At block 804, the apparatus can write evicted MT data cached in the data cache portion back to the main memory. For example, the cache controller can move the MT data from the data cache portion 206 (see FIG. 2) to the main memory.

At block 806, the apparatus (e.g., MTU 210 of FIG. 2) can coalesce the AT write commands using a write coalescing buffer (e.g., buffer 224 of FIG. 2). For example, the MTU can use write coalescing to optimize the handling of multiple AT write operations targeting the same cache line or region (e.g., AT sub-cache 222 of FIG. 2). Instead of performing each write operation individually, write coalescing combines multiple writes into a single operation, reducing the overhead associated with handling each write separately. In this case, the MTU can combine multiple AT write requests using write coalescing.

At block 808, the MTU can flush the coalescing buffer and write the AT back to the AT sub-cache (e.g., sub-cache 222 of FIG. 2) of the system cache. If the AT sub-cache has not room for the new AT, the MTU can replace older AT in the AT sub-cache with the new AT. Then, the MTU can write (evict) the older AT back to the main memory.

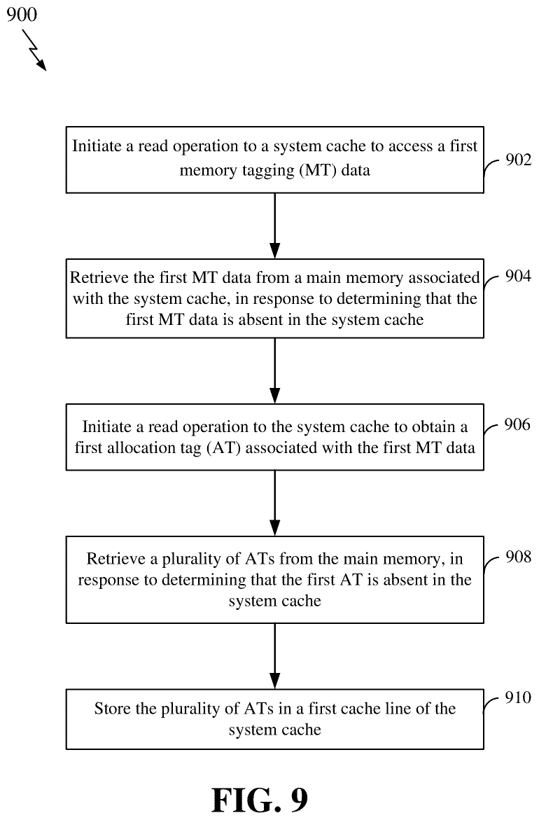

FIG. 9 is a flow chart illustrating an exemplary method 9000 for memory tagging using a system cache and a memory tagging unit in accordance with some aspects of the present disclosure. As described below, some or all illustrated features may be omitted in a particular implementation within the scope of the present disclosure, and some illustrated features may not be required for implementation of all examples. In some examples, the method 900 may be carried out at the computing apparatus described above in relation to FIGS. 1-8. In some examples, the method 900 may be carried out by any suitable apparatus or means for carrying out the functions or algorithm described below.

At block 902, the apparatus can initiate a read operation to a system cache to access a first memory tagging (MT) data. For example, the cache controller 208 of FIG. 2 can provide a means to read the system cache to access the first MT data, if available, in the system cache 108. For example, the first MT data, if available, may be stored in the data cache portion 206 of FIG. 2.

At block 904, the apparatus can retrieve the first MT data from a main memory associated with the system cache, in response to determining that the first MT data is absent in the system cache. For example, the cache controller 208 of FIG. 2 can provide a means to determine that the first MT data is absent (i.e., cache miss) in the system cache. For example, the cache controller 208 of FIG. 2 can provide a means to retrieve the first MT data from the main memory and store the first MT data at the MTU 210 of FIG. 2.

At block 906, the apparatus can initiate a read operation to the system cache to obtain a first allocation tag (AT) associated with the first MT data. For example, the MTU 210 of FIG. 2 can issue a read request to the cache controller 208 of FIG. 2 to retrieve the first AT, if available, from the system cache. For example, the first AT may be available in the AT sub-cache 222 (see FIG. 2) of the system cache. The AT sub-cache 222 can cache a plurality of ATs in a cache line.

At block 908, apparatus can retrieve a plurality of ATs from the main memory, in response to determining that the first AT is absent in the system cache. The plurality of ATs includes the first AT. For example, the cache controller 208 (FIG. 2) can provide a means to retrieve the plurality of ATs from the main memory. The cache controller can retrieve the plurality of ATs in a single prefetch operation.

At block 910, the apparatus can store the plurality of ATs in a first cache line of the system cache. For example, the cache controller 208 of FIG. 2 can provide a means to store the plurality of ATs in the same cache line (e.g., 64 bytes cache line). Then the cache controller can notify the MTU upon caching the plurality of ATs in the system cache.

At block 912, the apparatus can align the first AT and the first MT data in a second cache line of the system cache. For example, the MTU 210 of FIG. 2 can provide a means to align first AT and the first MT data. Aligning the first AT and the first MT data ensures that the first AT is correctly associated with the memory address or data block of the first MT data, and is stored alongside the first MT data in the same cache line. Storing the first AT and first MT data in the same cache line enables the apparatus to read the first AT and associated first MT data in a single read operation.

Additional aspects of the disclosure are provided below as further examples.

Clause 1: A computing apparatus comprising: a main memory; a system cache; and a memory controller coupled to the main memory and the system cache, the memory controller being configured to: initiate a read operation to the system cache to access a first memory tagging (MT) data; retrieve the first MT data from the main memory, in response to determining that the first MT data is absent in the system cache; initiate a read operation to the system cache to obtain a first allocation tag (AT) associated with the first MT data; retrieve a plurality of ATs from the main memory, in response to determining that the first AT is absent in the system cache, the plurality of ATs comprising the first AT; store the plurality of ATs in a first cache line of the system cache; and align the first AT and the first MT data in a second cache line of the system cache.

Clause 2: The computing apparatus of clause 1, wherein the memory controller is further configured to: initiate a read operation to the system cache to access a second MT data; retrieve the second MT data from the main memory, in response to determining that the second MT data is absent in the system cache; retrieve a second AT associated with the second MT data from the plurality of ATs stored in the first cache line of the system cache; align the second AT and the second MT data; and store the second AT and the second MT data in a third cache line of the system cache.

Clause 3: The computing apparatus of clause 1, wherein the memory controller is further configured to: initiate a read operation to the system cache to access a third MT data; retrieve a third AT associated with the third MT data from the plurality of ATs stored in the first cache line of the system cache; and store the third AT and the third MT data in a fourth cache line of the system cache.

Clause 4: The computing apparatus of clause 1, 2 or 3, wherein the memory controller is further configured to: retrieve, in a single read operation, the first AT and the first MT data from the second cache line of the system cache.

Clause 5: The computing apparatus of clause 1, 2 or 3, wherein the memory controller is further configured to: initiate a write operation to access a fourth MT data in the system cache, the write operation comprising: updating the fourth MT data in a fifth cache line of the system cache; and updating a fourth AT associated with fourth MT data, the fourth AT stored alongside the fourth MT data in the fifth cache line.

Clause 6: The computing apparatus of clause 5, wherein the memory controller is further configured to: initiate an evict operation to evict a sixth cache line of the system cache, the sixth cache line comprising a sixth MT data and a sixth AT associated with sixth MT data, the evict operation comprising: writing the sixth MT data back to the main memory; and writing the sixth AT to the first cache line of the system cache for future memory tagging use with the sixth MT data.

Clause 7: The computing apparatus of clause 6, wherein the memory controller is further configured to: coalesce a plurality of AT write operations including the sixth AT; and write the sixth AT back to the main memory.

Clause 8: A method of cache memory management in a computing apparatus, comprising: initiating a read operation to a system cache to access a first memory tagging (MT) data; retrieving the first MT data from a main memory associated with the system cache, in response to determining that the first MT data is absent in the system cache; initiating a read operation to the system cache to obtain a first allocation tag (AT) associated with the first MT data; retrieving a plurality of ATs from the main memory, in response to determining that the first AT is absent in the system cache, the plurality of ATs comprising the first AT; storing the plurality of ATs in a first cache line of the system cache; and aligning the first AT and the first MT data in a second cache line of the system cache.

Clause 9: The method of clause 8, further comprising: initiating a read operation to the system cache to access a second MT data; retrieving the second MT data from the main memory, in response to determining that the second MT data is absent in the system cache; retrieving a second AT associated with the second MT data from the plurality of ATs stored in the first cache line of the system cache; aligning the second AT and the second MT data; and storing the second AT and the second MT data in a third cache line of the system cache.

Clause 10: The method of clause 8, further comprising: initiating a read operation to the system cache to access a third MT data; retrieving a third AT associated with the third MT data from the plurality of ATs stored in the first cache line of the system cache; and storing the third AT and the third MT data in a fourth cache line of the system cache.

Clause 11: The method of clause 8, 9 or 10, further comprising: retrieving, in a single read operation, the first AT and the first MT data from the second cache line of the system cache.

Clause 12. The method of clause 8, 9 or 10 further comprising: initiating a write operation to access a fourth MT data in the system cache, comprising: updating the fourth MT data in a fifth cache line of the system cache; and updating a fourth AT associated with fourth MT data, the fourth AT stored alongside the fourth MT data in the fifth cache line.

Clause 13: The method of clause 12, further comprising: evicting a sixth cache line of the system cache, the sixth cache line comprising a sixth MT data and a sixth AT associated with sixth MT data, comprising: writing the sixth MT data back to the main memory; and writing the sixth AT to the first cache line of the system cache for future memory tagging use with the sixth MT data.

Clause 14: A computing apparatus comprising: a main memory configured to store memory tagging (MT) data and associated allocation tag (AT); a system cache configured to cache the MT data and the AT; and a memory controller configured to: store a first MT data of the MT data in a first cache line of the system cache; store a first AT associated with the first data, in the first cache line; and store a plurality of second ATs in a second cache line of the system cache.

Clause 15: The computing apparatus of clause 14, wherein the system cache comprises: a tag cache portion configured to cache the first AT; a data cache portion configured to cache the first MT data; and a sub-cache portion configured to cache the plurality of second ATs in a single prefetch operation of the main memory.

Clause 16: The computing apparatus of clause 15, wherein the memory controller comprises: a cache controller configured to control access of the system cache; and a memory tagging unit (MTU) configured to implement memory tagging functions in cooperation with the cache controller using the tag cache portion, the data cache portion, and the sub-cache portion.

Clause 17: The computing apparatus of clause 15 or 16, wherein the memory controller is further configured to change a size of the tag cache portion in response to caching operations of the tag cache portion.

Clause 18: The computing apparatus of clause 15 or 16, wherein the memory controller is further configured to: retrieve the plurality of the second ATs from the second cache line, in response to a cache miss of the tag cache portion; and allocate one or more of the plurality of second ATs in the tag cache portion, each second AT being allocated in a same cache line with a corresponding MT data.

Clause 19: The computing apparatus of clause 15 or 16, wherein the memory controller is further configured to: retrieve the plurality of second ATs from the main memory in a single fetch operation; and store the plurality of second ATs in the second cache line for later allocation in the tag cache portion.

Clause 20: The computing apparatus of clause 14, 15 or 16, wherein the memory controller comprises a write coalescing buffer configured to at least one of: merge a plurality of AT write operations into a single operation at the system cache; or merge a plurality of AT evict operations into a single operation at the system cache.

Several aspects of a data communication system have been presented with reference to an exemplary implementation. As those skilled in the art will readily appreciate, various aspects described throughout this disclosure may be extended to other data communication systems, network architectures and communication standards.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-9 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-9 may be configured to perform one or more of the methods, features, or steps described herein. The novel algorithms described herein may also be efficiently implemented in software and/or embedded in hardware to improve memory tagging operations using a system cache and a memory tagging unit.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

What is claimed is:

1. A computing apparatus comprising:
a main memory;
a system cache; and
a memory controller coupled to the main memory and the system cache,
the memory controller being configured to:
initiate a read operation to the system cache to access a first memory tagging (MT) data;
retrieve the first MT data from the main memory, in response to determining that the first MT data is absent in the system cache;
initiate a read operation to the system cache to obtain a first allocation tag (AT) associated with the first MT data;
retrieve a plurality of ATs from the main memory, in response to determining that the first AT is absent in the system cache, the plurality of ATs comprising the first AT;
store the plurality of ATs in a first cache line of the system cache; and
align the first AT and the first MT data in a second cache line of the system cache.

2. The computing apparatus of claim 1, wherein the memory controller is further configured to:
initiate a read operation to the system cache to access a second MT data;
retrieve the second MT data from the main memory, in response to determining that the second MT data is absent in the system cache;
retrieve a second AT associated with the second MT data from the plurality of ATs stored in the first cache line of the system cache;
align the second AT and the second MT data; and
store the second AT and the second MT data in a third cache line of the system cache.

3. The computing apparatus of claim 1, wherein the memory controller is further configured to:
initiate a read operation to the system cache to access a third MT data;
retrieve a third AT associated with the third MT data from the plurality of ATs stored in the first cache line of the system cache; and
store the third AT and the third MT data in a fourth cache line of the system cache.

4. The computing apparatus of claim 1, wherein the memory controller is further configured to:
retrieve, in a single read operation, the first AT and the first MT data from the second cache line of the system cache.

5. The computing apparatus of claim 1, wherein the memory controller is further configured to:
initiate a write operation to access a fourth MT data in the system cache, the write operation comprising:
updating the fourth MT data in a fifth cache line of the system cache; and
updating a fourth AT associated with fourth MT data, the fourth AT stored alongside the fourth MT data in the fifth cache line.

6. The computing apparatus of claim 5, wherein the memory controller is further configured to:
initiate an evict operation to evict a sixth cache line of the system cache, the sixth cache line comprising a sixth MT data and a sixth AT associated with sixth MT data, the evict operation comprising:
writing the sixth MT data back to the main memory; and
writing the sixth AT to the first cache line of the system cache for future memory tagging use with the sixth MT data.

7. The computing apparatus of claim 6, wherein the memory controller is further configured to:
coalesce a plurality of AT write operations including the sixth AT; and
write the sixth AT back to the main memory.

8. A method of cache memory management in a computing apparatus, comprising:
initiating a read operation to a system cache to access a first memory tagging (MT) data;
retrieving the first MT data from a main memory associated with the system cache, in response to determining that the first MT data is absent in the system cache;
initiating a read operation to the system cache to obtain a first allocation tag (AT) associated with the first MT data;
retrieving a plurality of ATs from the main memory, in response to determining that the first AT is absent in the system cache, the plurality of ATs comprising the first AT;
storing the plurality of ATs in a first cache line of the system cache; and
aligning the first AT and the first MT data in a second cache line of the system cache.

9. The method of claim 8, further comprising:
initiating a read operation to the system cache to access a second MT data;
retrieving the second MT data from the main memory, in response to determining that the second MT data is absent in the system cache;
retrieving a second AT associated with the second MT data from the plurality of ATs stored in the first cache line of the system cache;
aligning the second AT and the second MT data; and
storing the second AT and the second MT data in a third cache line of the system cache.

10. The method of claim 8, further comprising:
initiating a read operation to the system cache to access a third MT data;
retrieving a third AT associated with the third MT data from the plurality of ATs stored in the first cache line of the system cache; and
storing the third AT and the third MT data in a fourth cache line of the system cache.

11. The method of claim 8, further comprising:
retrieving, in a single read operation, the first AT and the first MT data from the second cache line of the system cache.

12. The method of claim 8, further comprising:
initiating a write operation to access a fourth MT data in the system cache, comprising:
updating the fourth MT data in a fifth cache line of the system cache; and
updating a fourth AT associated with fourth MT data, the fourth AT stored alongside the fourth MT data in the fifth cache line.

13. The method of claim 12, further comprising:
evicting a sixth cache line of the system cache, the sixth cache line comprising a sixth MT data and a sixth AT associated with sixth MT data, comprising:
writing the sixth MT data back to the main memory; and
writing the sixth AT to the first cache line of the system cache for future memory tagging use with the sixth MT data.

14. A computing apparatus comprising:
a main memory configured to store memory tagging (MT) data and associated allocation tag (AT);
a system cache configured to cache the MT data and the AT; and
a memory controller coupled to the main memory and the system cache,
the memory controller configured to:
store a first MT data of the MT data in a first cache line of the system cache;
store a first AT associated with the first MT data, in the first cache line; and
store a plurality of second ATs in a second cache line of the system cache.

15. The computing apparatus of claim 14, wherein the system cache comprises:
a tag cache portion configured to cache the first AT;
a data cache portion configured to cache the first MT data; and
a sub-cache portion configured to cache the plurality of second ATs in a single prefetch operation of the main memory.

16. The computing apparatus of claim 15, wherein the memory controller comprises:
a cache controller configured to control access of the system cache; and
a memory tagging unit (MTU) configured to implement memory tagging functions in cooperation with the cache controller using the tag cache portion, the data cache portion, and the sub-cache portion.

17. The computing apparatus of claim 15, wherein the memory controller is further configured to change a size of the tag cache portion in response to caching operations of the tag cache portion.

18. The computing apparatus of claim 15, wherein the memory controller is further configured to:
retrieve the plurality of the second ATs from the second cache line, in response to a cache miss of the tag cache portion; and
allocate one or more of the plurality of second ATs in the tag cache portion, each second AT being allocated in a same cache line with a corresponding MT data.

19. The computing apparatus of claim 15, wherein the memory controller is further configured to:
retrieve the plurality of second ATs from the main memory in a single fetch operation; and
store the plurality of second ATs in the second cache line for later allocation in the tag cache portion.

20. The computing apparatus of claim 14, wherein the memory controller comprises a write coalescing buffer configured to at least one of:
merge a plurality of AT write operations into a single operation at the system cache; or
merge a plurality of AT evict operations into a single operation at the system cache.
